(19) United States
(12) Patent Application Publication
(10) Pub. No.: US 2012/0201433 A1
(43) Pub. Date: Aug. 9, 2012

(54) Image composition system

(75) Inventors: Tomoki IWASAKI, Tokyo (JP); Yuji KUTSUMA, Tokyo (JP)

(73) Assignee: OLYMPUS MEDICAL SYSTEMS CORP., Tokyo (JP)

(21) Appl. No.: 13/343,311

(22) Filed: Jan. 4, 2012

Related U.S. Application Data
(63) Continuation of application No. PCT/JP2011/064793, filed on Jun. 28, 2011.

(30) Foreign Application Priority Data
Jul. 13, 2010 (JP) 2010-158953

(51) Int. Cl. G06K 9/36

(52) U.S. Cl. 382/128; 382/284

(57) ABSTRACT

An image composition system includes: an image related information acquiring portion that acquires image related information between a first image and a second image; an image display form designating portion that designates a display form of the first image preferentially to the second image; a second image display form determining portion that determines a display form of the second image so as to display the second image in a predetermined area of the first image; a second image processing portion that processes the second image; and an image compositing portion that outputs a composite image obtained by compositing the second image processed by the second image processing portion on the predetermined area of the first image.

### CROSS REFERENCE TO RELATED APPLICATION

This application is a continuation application of PCT/JP2011/064793 filed on Jun. 28, 2011 and claims benefit of Japanese Application No. 2010-158953 filed in Japan on Jul. 13, 2010, the entire contents of which are incorporated herein by this reference.

### BACKGROUND OF THE INVENTION

1. Field of the Invention

The present invention relates to an image composition system that composites a plurality of images into a primary/secondary image and displays the resultant image.

2. Description of the Related Art

In recent years, endoscope apparatuses as medical equipment have been widely utilized in which an endoscope can be used to examine an affected area or the like in a body and to carry out treatment with a treatment instrument as needed.

Also, systems have been proposed in which a plurality of endoscopes are connected with each other so as to observe an affected area or the like in more detail or an external device having a different function is connected to the system to display a plurality of images on a common display device.

As systems that display a plurality of images, Japanese Patent Application Laid-Open Publication No. 2009-189556 being a first example of conventional arts has disclosed a system with a plurality of X-ray image pickup systems that designates dispositions of a plurality of images and displays them as a composite image on a display device.

Also, Japanese Patent Application Laid-Open Publication No. 2008-307294 being a second example of the conventional arts has disclosed a system that controls display depending on the number of pixels of an image pickup device.

### SUMMARY OF THE INVENTION

An image composition system according to an aspect of the present invention, for receiving a first image and a second image and outputting a composite image, comprises: an image related information acquiring portion that acquires image related information between the first image and the second image; an image display form designating portion that designates a display form of the first image preferentially to the second image; a second image display form determining portion that determines a display form of the second image to display the second image in a predetermined area of the first image based on the image related information of the second image, the information being acquired by the image related information acquiring portion, and the designation of the image display form designating portion; a second image processing portion that processes the second image based on the determination by the second image display form determining portion; and an image compositing portion that outputs a composite image obtained by compositing the second image processed by the second image processing portion on the predetermined area of the first image.

### BRIEF DESCRIPTION OF THE DRAWINGS

FIG. 1 is a diagram illustrating an overall configuration of an image composition system according to a first embodiment of the present invention;

FIG. 2 is a diagram illustrating an internal configuration of a processor and a light source apparatus in FIG. 1;

FIG. 3 is a block diagram illustrating a detailed configuration of an image signal processing portion in FIG. 2;

FIG. 4 is a diagram illustrating a disposition example of a primary image and related data;

FIG. 5A is an explanatory diagram illustrating, in the case of a large endoscope picture, how an endoscope image cut out so as to include the picture is reduced and disposed in a secondary image area as a secondary image;

FIG. 5B is an explanatory diagram illustrating, in the case of a small endoscope picture, how an endoscope image cut out so as to include the picture is reduced and disposed in a secondary image area as a secondary image;

FIG. 6 is a block diagram illustrating, in the configuration in FIG. 3 in which a disposition setting circuit is provided, a configuration around the disposition setting circuit;

FIG. 7A is a diagram illustrating a disposition example of a primary image and related data disposed in an image memory in a PinP composition circuit;

FIG. 7B is another diagram illustrating a disposition example of a primary image and related data different from FIG. 7A and disposed in the image memory in the PinP composition circuit;

FIG. 8 is a diagram illustrating a display example of a composite image generated with a set aspect ratio;

FIG. 9 is a diagram illustrating an example in which a secondary image is cut out as a cutout area according to a type of an endoscope;

FIG. 10 is a diagram illustrating an overall configuration of an image composition system of a second embodiment of the present invention; and

FIG. 11 is a block diagram illustrating a partial configuration of an image signal processing portion according to an image composition system of a third embodiment of the present invention.

### DETAILED DESCRIPTION OF THE PREFERRED EMBODIMENTS

Embodiments of the present invention will now be described with reference to the drawings.

### First Embodiment

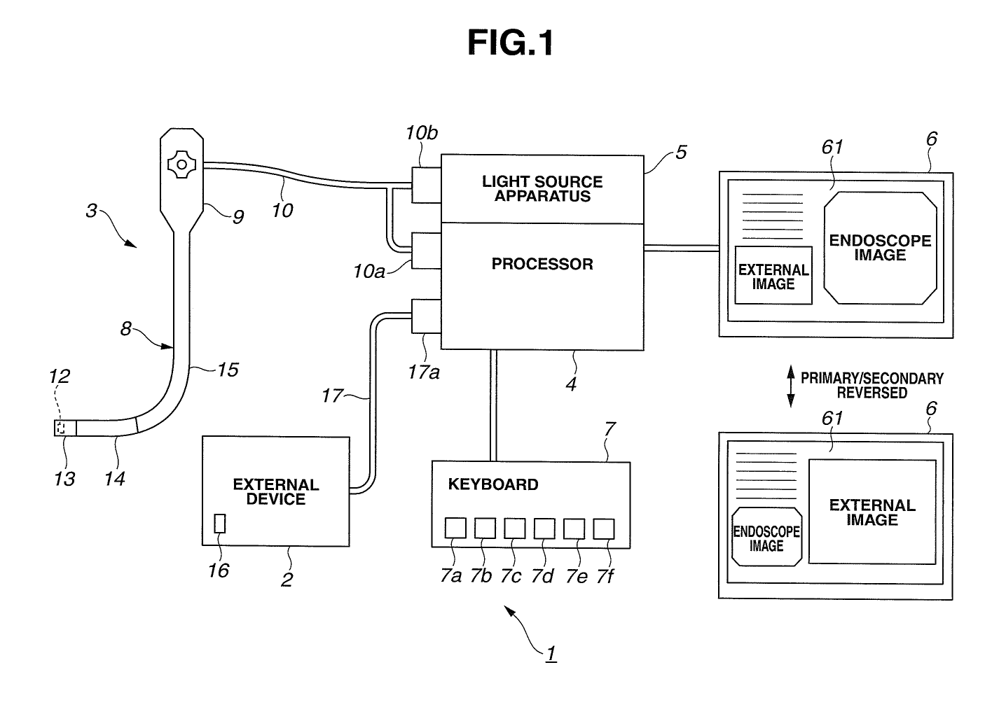

As illustrated in FIG. 1, an image composition system 1 according to a first embodiment of the present invention includes an external device 2 being first medical equipment, an endoscope 3 being second medical equipment inserted into a body cavity and used for endoscopy, a processor 4 through which the external device 2 and the endoscope 3 are detachably connected with each other, for performing image processing to generate a composite image, a light source apparatus 5 that supplies illuminating light to the endoscope 3, a monitor 6 being a display device that is connected with the processor 4 and displays a primary/secondary image being a composite image of a plurality of images, and a keyboard 7, for example, as an external inputting device.

The endoscope 3 includes an elongated insertion portion 8 to be inserted into a body cavity, an operation portion 9 provided at a distal end of the insertion portion 8, and a universal cable 10 extended from the operation portion 9. An electrical connector 10a provided at an end of the universal cable 10 is detachably connected with the processor 4.

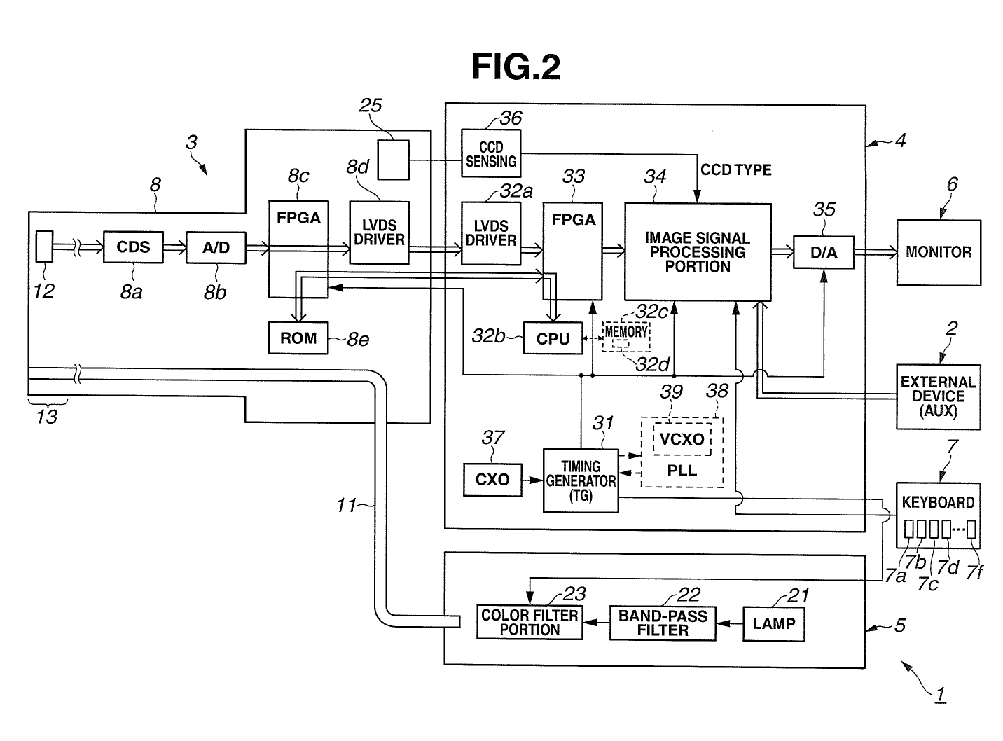

A light guide connector 10b at an end of the universal cable 10 is detachably connected with the light source apparatus 5. The light source apparatus 5 supplies illuminating light to a light guide 11 (see FIG. 2) in the endoscope 3 via the light guide connector 10b. FIG. 2 illustrates an internal configuration of the endoscope 3, the processor 4, and the light source apparatus 5.

The insertion portion 8 includes a distal end portion 13 incorporating an electrical charge coupled device (abbreviated as CCD) 12 being an image pickup device, a bendable bending portion 14, and an elongated flexible portion 15.

As illustrated in FIG. 2, the light guide 11 transmits the supplied illuminating light to an emitting end disposed at an illuminating window of the distal end portion 13 and emits the illuminating light from the illuminating window to illuminate a site to be an image pickup target such as an affected area, an image of which is picked up by the CCD 12.

Signals of the image picked up by the CCD 12 mounted in the endoscope 3 are inputted to a correlated double sampling circuit (CDS circuit) 8a provided in the endoscope 3 (e.g., in the insertion portion 8 or the operation portion 9). The CDS circuit 8a performs CDS processing on the image pickup signals to generate baseband image signals, and outputs the generated signals to an A/D converting circuit 8b. A/D converted image signals are inputted to a first FPGA (Field Programmable Gate Array) 8c that performs parallel/serial conversion processing, then to, for example, an LVDS driver 8d being a line driver with a low amplitude differential signal scheme (Low-Voltage Differential Signaling), and to an LVDS receiver 32a in the processor 4 via the electrical connector 10a.

The signals received at the LVDS receiver 32a are serial/parallel converted through a second FPGA 33 and then inputted to an image signal processing portion 34. Also, a ROM 8e in which scope information is stored is provided in the endoscope 3, and the scope information in the ROM 8e is taken by a CPU 32b in the processor 4 via FPGAs 8c and 32a.

Also, as illustrated in FIG. 1, signals of an image picked up by, for example, a CCD 16 being an image pickup device incorporated in the external device 2 are inputted to the processor 4 via a cable 17 extended from the external device 2 and an electrical connector 17a at an end of the cable 17.

That is, each of the endoscope 3 and the external device 2 forms image signal outputting means for outputting image signals corresponding to an image picked up by the image pickup device of each of the endoscope 3 and the external device 2.

It should be noted that as described later, the external device 2 is not limited to a device that outputs image signals obtained by an optical image pickup device, and may also be a device that outputs ultrasound image signals obtained by an ultrasound transducer being an acoustic image pickup device.

The processor 4 includes the image signal processing portion 34 (see FIG. 2) that performs image compositing processing for generating a composite image obtained by compositing a plurality of images inputted from a plurality of image signal outputting means, and outputs image signals of the generated composite image to the monitor 6.

If a plurality of images are composited and displayed on the monitor 6, a user such as an operator has a function of instruction inputting means for inputting through the keyboard 7 an instruction to designate a display form of the composite image.

Specifically, a composite image has a display form of a primary/secondary image or a primary/secondary screen (abbreviated as picture-in-picture or PinP) including a primary image or a primary screen in which one image is basically displayed preferentially (to the other image) without changing the size or the like of the image and a secondary image or a secondary screen obtained by expanding or reducing the other image and incorporating the resultant image in the primary screen.

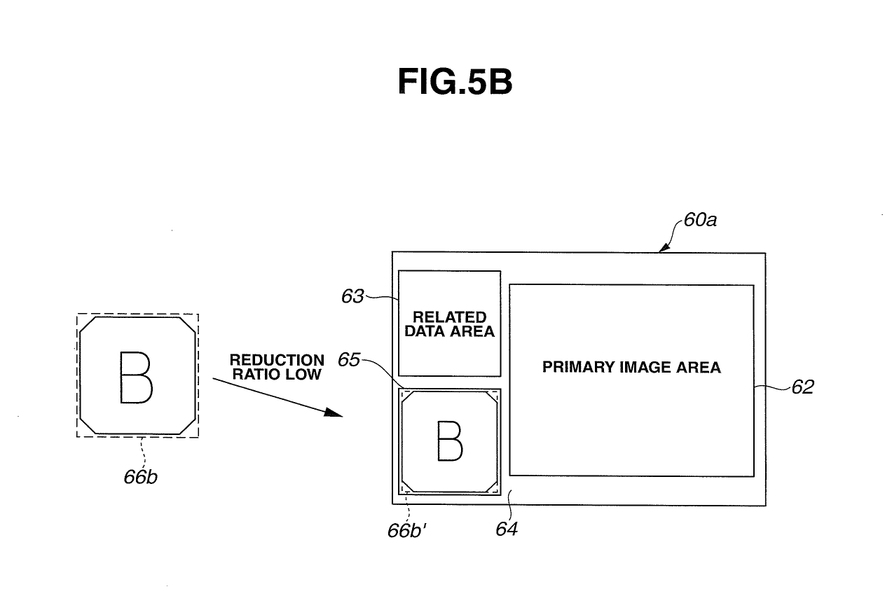

Further, in the present embodiment, as described with reference to FIG. 6 or subsequent figures, a disposition of a primary image can be changed, and a position of a secondary image can also be appropriately changed in response to the change of the primary image. It should be noted that in many instances, original images of secondary images are reduced in size, but secondary images may also be increased in size depending on the size of display area for the secondary images.

Also, as used in the present embodiment, the term primary screen mainly means a screen including a primary image and related data relating to the primary image, and in a case where only the primary image part is referred to, the term primary image is used. The term secondary screen is also used in the same manner.

The keyboard 7 has, for example, a function of a first image designating portion 7a being first image designating means for providing an instruction to display a first image among a plurality of images, a function of a second image designating portion 7b being second image designating means for providing an instruction to display a second image among a plurality of images, and a function of a first image display form designating portion 7c being first image display form designating means for providing an instruction to display a first image designated by the first image designating means preferentially to a second image.

A display example of a composite image on a display screen 61 of the upper monitor 6 shown in FIG. 1 is a display form example of PinP in which an endoscope image being a second medical image picked up by the endoscope 3 is displayed as a primary image and an image (referred to as the external image) generated by the external device 2 is displayed as a secondary image through the keyboard 7.

Also, a display example on the lower monitor 6 shown in FIG. 1 is a display form example of PinP (primary/secondary image) in which an external image generated by the external device 2 is displayed as a primary image and an endoscope image picked up by the endoscope 3 is displayed as a secondary image through the keyboard 7.

Also, in the image composition system 1 of the present embodiment, the two display forms of PinP displayed on the upper and lower monitors 6 in FIG. 1 can be reversed in response to instruction input from the keyboard 7.

As such, the present embodiment has a function to display an image in PinP in response to instruction input from the keyboard 7.

A display area above a secondary image in FIG. 1 is for an image of data relating to a medical image such as character data of a patient in association with a primary image (hereinafter, abbreviated as the related data). The processor 4 generates a composite image in PinP in which a plurality of, in particular, two medical images and an image of related data are composited, and outputs image signals of the composite image to the monitor 6. The monitor 6 displays the generated composite image. For simplicity, an image of related data will be simply referred to as the related data.

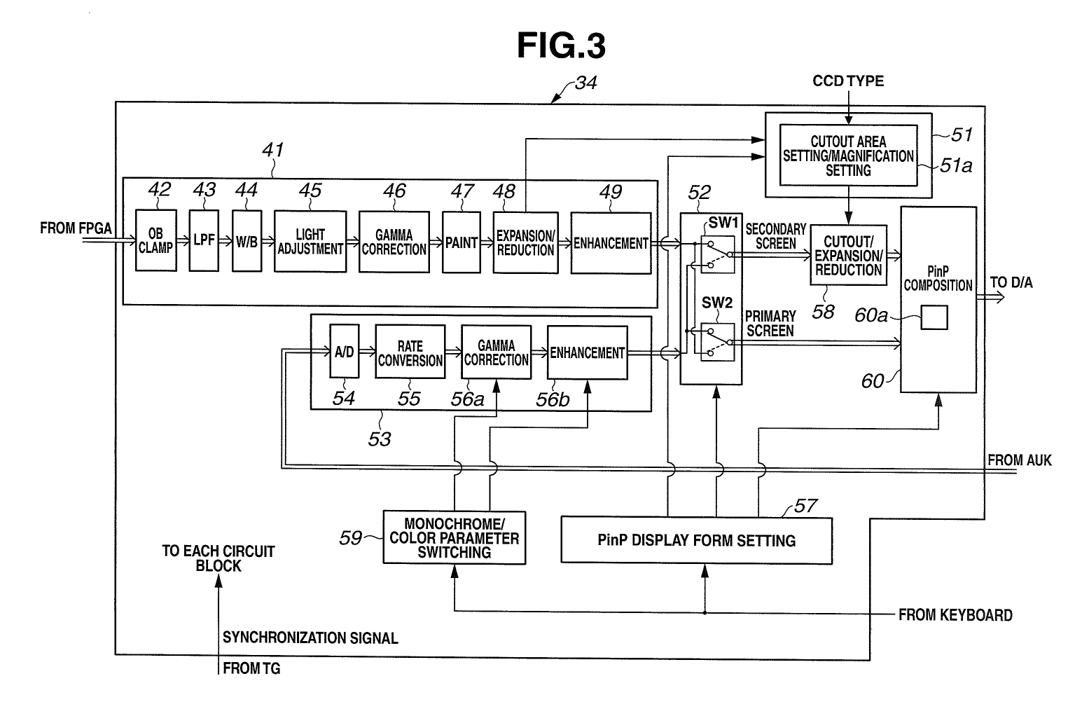

The processor 4 includes an information acquiring portion 51 (see FIG. 3) being image related information acquiring means for acquiring a plurality of medical images and image related information on related data. Also, the processor 4 includes a PinP display form setting portion 57 (see FIG. 3) forming second image display form determining means for determining a display form of information related to a second image to be displayed as a secondary image acquired by the information acquiring portion 51 and the second image designated by the first image display form designating means.

As illustrated in FIG. 2, the light source apparatus 5 includes a light emitting lamp 21. A band-pass filter 22 which limits a band such that it transmits only light from the lamp 21 of a wavelength band within a visible range and does not transmit light of a wavelength band within an infrared range and the like.

Light in the visible range transmitted by the band-pass filter 22 is converted into frame-sequential illuminating light of, for example, red (R), green (G), and blue (B) by a color filter portion 23 and is incident on (supplied to) an incident end of the light guide 11. Then, an emitting end of a distal end of the light guide 11 emits the transferred illuminating light to illuminate a site in a body such as an affected area.

The color filter portion 23 includes a motor that is not shown, rotation color filters rotated by the motor and provided with R, G, and B color filters that transmit R, G, and B lights, respectively, and a motor driving circuit that drives the motor at a predetermined rotation rate. The R, G, and B color filters are sequentially disposed on an optical path.

The site illuminated by the frame-sequential illuminating light is picked up by the CCD 12, and image pickup signals photoelectrically converted by the CCD 12 are converted into digital signals through the CDS circuit 8a and the A/D converting circuit 8b, thereafter being outputted to one input end of the image signal processing portion (video signal processing portion) 34 that generates a composite image in PinP through the FPGAs 8c and 33. Image signals of an external image from the external device (AUX) are inputted to the other input end of the image signal processing portion 34.

The image signal processing portion 34 generates a composite image in PinP from image signals inputted from the two input ends, and composite image signals being image signals of the generated composite image are converted into analog composite image signals by a D/A converting circuit 35, thereafter being outputted to the monitor 6. The display screen 61 of the monitor 6 displays the composite image in PinP.

Also, each endoscope 3 incorporates an ID producing portion) 25 that produces, for example, unique identification information (ID), the ID producing portion 25 being information producing means for producing endoscope information including information such as the number of pixels (including the size of the number of horizontal and vertical pixels) of the CCD 12 incorporated in each endoscope 3 and a type of the endoscope 3 (e.g., whether a medical endoscope or a surgical endoscope).

The ID producing portion 25 is, for example, provided in the electrical connector 10a. Thus, when the electrical connector 10a is connected with the processor 4, an ID produced by the ID producing portion 25 is inputted to an (ID sensing or) a CCD sensing circuit 36 in the processor 4. The CCD sensing circuit 36 determines from the ID a type of the CCD 12 such as the number of pixels of the CCD 12 in which the endoscope 3 is incorporated to output information of the CCD type to the information acquiring portion 51 (see FIG. 3) in the image signal processing portion 34.

Also, the processor 4 includes a timing generator (TG abbreviated as) 31 that produces a timing signal for determining a timing at which each process is performed, and the processor 4 outputs a synchronization signal being a timing signal generated by the TG 31 to the FPGA 33, the image signal processing portion 34, and the D/A converting circuit 35 being circuit blocks in the processor 4, as well as to the FPGA 8c in the endoscope 3. A synchronization signal is also supplied to each circuit block constituting the image signal processing portion 34 shown in FIG. 3.

The TG 31 generates a synchronization signal in synchronization with a reference clock from, for example, a crystal oscillation circuit (abbreviated as the CXO circuit) 37 being reference clock producing means. Synchronization signals include a horizontal synchronization signal, a vertical synchronization signal, and a clock synchronous with both the synchronization signals that are used to display an image.

Also, the TG 31 outputs R, G, and B index signals being timing signals to the color filter portion 23 of the light source apparatus 5, and the color filter portion 23 sequentially disposes R, G, and B color filters on an optical path in synchronization with the R, G, and B index signals.

Thus, image pickup signals picked up by the CCD 12 are actually image pickup signals of R, G, and B picked up under the illuminating light of R, G, and B and are converted into colored image signals in the image signal processing portion 34.

Also, the processor includes a Phase Locked Loop circuit (PLL circuit) 38 indicated by a dotted line in addition to the CXO circuit 37. The PLL circuit 38 incorporates a voltage control crystal oscillation circuit (VCXO) 39 therein that can adjust an oscillation frequency based on a voltage value. The PLL circuit 38 is used to allow operation in synchronization with a signal from an apparatus outside the processor 4.

The image signal processing portion 34 receives a variety of instruction signals corresponding to instruction inputs through the keyboard 7 having the various functions described above.

FIG. 3 illustrates a detailed configuration example of the image signal processing portion 34. Image signals outputted from the A/D converting circuit 33 in FIG. 2 are inputted to an optical black clamp circuit (OB clamp circuit) 42 being a component of an endoscope image signal processing portion 41 that configures first or second image processing means.

The OB clamp circuit 42 sets a black level of an image pickup signal used for actual image pickup in the CCD 12 to a clamp level of an OB part and the black level of the image pickup signal is reproduced.

After a low-pass filter circuit (LPF circuit) 43 filters out an unnecessary high-frequency component of the output signal from the OB clamp circuit 42, the output signal is inputted to a white balance circuit (W/B circuit) 44. The W/B circuit 44 adjusts W/B so as to output a white image signal if an image of a white object is picked up.

The W/B circuit 44 includes a frame memory for the storage of image signals of color components of R, G, and B, each of which is generated by the CCD 12 picking up an image under illuminating light of, for example, three frames of frame-sequential image signals, specifically, frame-sequential illuminating light of R, G, and B, and also includes a synchronization circuit that simultaneously reads out image signals of color components of R, G, and B stored in the frame memory, thereby simultaneously outputting colored image signals. It should be noted that the synchronization circuit may be provided subsequently to the W/B circuit 44.

Output signals from the W/B circuit 44 are inputted to a light adjustment circuit 45 as well as inputted to a gamma circuit 46 that performs gamma correction. The light adjustment circuit 45 generates light adjustment signals for light adjustment from color signals of R, G, and B and outputs the light adjustment signals to the light source apparatus 5.

The light source apparatus 5 adjusts an aperture value of a diaphragm that is not shown using light adjustment signals to adjust an illuminating light amount, that is, to perform light adjustment.

An output signal from the gamma circuit 46 is inputted to a paint circuit 47 that enables adjusting a color-tone. An output signal from the paint circuit 47 is inputted to an expansion/reduction circuit 48 that performs expansion or reduction processing. An output signal from the expansion/reduction circuit 48 is inputted to an enhancing circuit 49 that enhances an edge and the like.

If the expansion/reduction circuit 48 performs expansion or reduction, information of an expansion or a reduction ratio is inputted to the information acquiring portion 51, so that the information acquiring portion 51 acquires the information of the number of pixels of the CCD 12 and also the information on an expansion or a reduction ratio if an endoscope image is expanded or reduced by the expansion/reduction circuit 48. Then, the information acquiring portion 51 corrects the size of the endoscope image of the number of pixels of the CCD 12 using the information of the expansion or the reduction ratio to set (determine) a cutout area and the like described later.

The enhancing circuit 49 performs enhancing as well as masking that cuts four corners of a tetragonal endoscope image part of the enhanced image signals into an octagon. The masked image signals are inputted to one input end of a switching circuit 52 that switches between a primary screen and a secondary screen. It should be noted that as described later, masking is performed for a medical endoscope, but not for a surgical endoscope.

On the other hand, image signals corresponding to an external image from the external device 2 are inputted to an A/D converting circuit 54 being a component of an external image signal processing portion 53, and converted into digital image signals, thereafter being inputted to a rate conversion circuit 55 that converts the rate of an image signal.

The rate conversion circuit 55 performs rate conversion that converts a frequency of image signals from the external device 2 such that a standard of a display form of the image signals becomes the same standard as that adopted for the image signal processing portion 34 incorporated in the processor 4 that performs image processing on the CCD 12 of the endoscope 3. For example, if the processor 4 set to perform image processing of a standard (SD) receives image signals of a high definition standard (HD) from the external device 2, the rate conversion circuit 55 converts the rate such that HD image signals become SD image signals.

Thus, in the case of the same signal standards, the rate conversion circuit 55 does not perform rate conversion and passes an input signal a gamma circuit 56a that performs gamma correction. An output signal from the gamma circuit 56a is inputted to an enhancing circuit 56b that performs enhancing processing.

In the gamma circuit 56a and the enhancing circuit 56a, characteristics of gamma correction and enhancement are changed based on parameters from a monochrome/color parameter switching circuit 59.

In normal setting of the monochrome/color parameter switching circuit 59, parameters of characteristics corresponding to color image signals are set.

On the other hand, if a monochrome image signal such as an ultrasound image signal is inputted, by notifying, for example, through the keyboard 7 the monochrome/color parameter switching circuit 59 that the monochrome image signal is to be inputted, the monochrome/color parameter switching circuit 59 sets parameters, to the gamma circuit 56a and the enhancing circuit 56b, of characteristics for gamma correction and enhancement corresponding to monochrome image signals.

In this manner, if a composite image is generated by changing parameters for image processing in accordance with the case where image signals inputted from the external device 2 are colored or monochrome, the gradation and the edge of the image and the like from the external device 2 can be more properly displayed.

An output signal from the enhancing circuit 56b is inputted to the other input end of the switching circuit 52. The switching circuit 52 is composed of two switches SW1 and SW2 that enable reversing a primary/secondary relationship of an external image to be inputted and an endoscope image.

The switching circuit 52 is controlled by a PinP display form setting signal outputted by the PinP display form setting portion 57, which sets (or determines) a PinP display form based on the PinP display form designation inputted through the keyboard 7.

PinP display form setting signals are binary signals that can change the two switches SW1 and SW2 in conjunction with each other.

For example, if an instruction is provided through the keyboard 7 to designate a PinP display form in which an external image from the external device 2 is a primary image or a primary screen and an endoscope image from the endoscope 3 is a secondary image or a secondary screen, the PinP display form setting portion 57 sets the switches SW1 and SW2 of the switching circuit 52 to a state denoted by solid lines.

Also, if an instruction is provided through the keyboard 7 to designate a PinP display form in which an endoscope image from the endoscope 3 is a primary image or a primary screen and an external image from the external device 2 is a secondary image or a secondary screen, the PinP display form setting portion 57 sets the switches SW1 and SW2 of the switching circuit 52 to a state denoted by dotted lines.

The present embodiment is not limited to the foregoing case where an instruction to designate a PinP display form is provided, and by designating a display form of a primary image or a primary screen that is a preferential image, without designating the display form of a secondary image or a secondary screen, the PinP display form setting portion 57 configuring the second image display form determining means determines the change of the switches SW1 and SW2 to display the images as a primary/secondary image.

If one of an endoscope image and an external image is designated to be displayed as a first image (specifically, a primary image) in preference to the other image, one of the endoscope image signal processing portion 41 and the external image signal processing portion 53 forms first image processing means for performing image processing on the first image and the other subordinately forms second image processing means.

An output signal from the switch SW1 that outputs image signals of a secondary screen passes through the cutout/expansion/reduction circuit 58 and is inputted to one input end of a PinP composition circuit 60 being image composition means that generates a composite image in PinP.

On the other hand, an output signal from the switch SW2 that outputs image signals of a primary screen is directly inputted to the other input end of the PinP composition circuit 60. The PinP composition circuit 60 performs image processing that generates a composite image in PinP by assigning output signals from the switch SW2 to a primary image of a primary screen and disposing a secondary image to a blank area of the primary screen.

Thus, the PinP composition circuit 60 includes an image area (or an image disposition area) as an image memory 60a for the display area in the display screen 61 of the monitor 6 in FIG. 1, and based on the setting of a primary screen or a primary image provided by the PinP display form setting portion 57, the primary image configuring the primary screen and data relating to the primary image are disposed (stored) in the image memory 60a. Then, a secondary image is disposed in a remaining blank area in which the primary image and the related data are not disposed.

In the configuration example shown in FIG. 3, if an instruction input is provided to designate an image inputted from the external device 2 as a primary image, positions and sizes of the image inputted from the external device 2 and related data themselves are set as positions and sizes of a primary image and related data in the image memory 60a as they are.

Thus, in the configuration example shown in FIG. 3, by deciding a type of an image outputted from the external device 2 through an input from the keyboard 7, an area of positions and sizes where a primary image and related data are disposed is determined, and a secondary image area for a secondary image is set in a blank area other than the determined area. Also, if a secondary image is disposed in a secondary image area, in order to cut a secondary image part out from image signals of a secondary screen, the information acquired by the information acquiring portion 51 is used.

The information acquiring portion 51 includes a cutout area/magnification setting portion 51a that sets (determines) a cutout area for a secondary image part to be cut out from image signals of a secondary screen based on the acquired information, and magnification of expanding or reducing the secondary image part of the cutout area in order to hold the maximum possible size of the cut-out secondary image part in the secondary image area.

Information for setting a display form of a primary image is inputted to the information acquiring portion 51 from the PinP display form setting portion 57, which sets a display form of PinP as a composite image. Then, the information acquiring portion 51 sets a display form of a secondary image based on the information of the display form of the primary image. It should be noted that as indicated by arrows in FIG. 3, the information acquiring portion 51 and the PinP display form setting portion 57 may be configured to use information of each other.

Also, the cutout area/magnification setting portion 51a may be provided outside the information acquiring portion 51. Also, for example, the cutout area/magnification setting portion 51 a may also be provided in the PinP display form setting portion 57. The cutout area/magnification setting portion 51a and the PinP display form setting portion 57 form secondary image display form determining means for determining a display form of a secondary image. It should be noted that as in the case of a third embodiment described later, a cutout area may also be automatically set using edge extraction from image signals themselves.

The image composition system 1 of the present embodiment having such a configuration is an image composition system that outputs a composite image of a plurality of images inputted from a plurality of image signal outputting means, the image composition system including: the information acquiring portion 51 being image related information acquiring means for acquiring information such as the number of pixels of the CCD 12 being image related information to the images and an expansion or a reduction ratio used by the expansion/reduction circuit 48; and the first image designating portion 7a being first image designating means composed of the keyboard 7, through which an instruction is provided to display a first image among a plurality of the inputted images.

Also, the image composition system 1 includes a second image designating portion 7b being second image designating means composed of the keyboard 7, through which an instruction is provided to display a second image among a plurality of the inputted images; and a first image display form designating portion 7c being first image display form designating means composed of the keyboard 7, through which an instruction is provided to designate a display form of the first image designated by the first image designating means, preferentially to a the second image.

Also, the image composition system 1 includes the PinP display form setting portion 57 configuring second image display form determining means for determining a display form of the second image based on the image related information to the second image acquired by the image related information acquiring means and the display form of the first image designated by the first image display form designating means.

Also, the image composition system 1 includes the endoscope image signal processing portion 41, the external image signal processing portion 53, the switching circuit 52, and the cutout/expansion/reduction circuit 58 that are first image processing means for processing the first image in accordance with an instruction from the first image display form designating means and second image processing means for processing the second image in accordance with the determination made by the second image display form determining means.

Also, the image composition system 1 includes the PinP composition circuit 60 being image composition means for compositing the first image processed by the first image processing means and the second image processed by the second image processing means based on the instruction from the first image display form designating means and the determination made by the second image display form determining means.

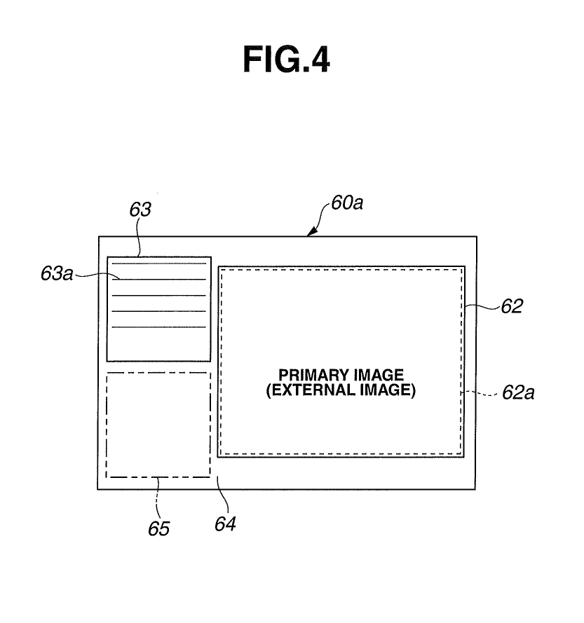

FIG. 4A illustrates a standard disposition example of a primary image forming a primary screen and related data. In an image disposition area of the image memory 60a set in accordance with the display screen 61, a primary image 62a being an external image from the external device 2 is disposed in a primary image area 62 and a related data 63a to the primary image 62a is disposed in a related data area 63.

Other than the primary image area 62 in the image memory 60a and the area for the data relating to the primary image 62a, an area in which nothing is displayed (in the monitor 6) is a blank area 64 where a secondary screen can be disposed. Then, as indicated by two-dot chain lines in the blank area 64, a secondary image area 65 for displaying a secondary image (a secondary screen) is set.

Then, the above-described cutout/expansion/reduction circuit 58 cuts and expands or reduces a secondary image part so as to cut the secondary image part out from image signals of a secondary screen outputted from the switch SW1 and dispose the secondary image part in a maximum possible size in the secondary image area 65.

In this case, even if the number of pixels of the CCD 12 of the endoscope 3 displayed as a secondary image is different, cutout of an endoscope image part and expansion or reduction of the cut-out endoscope image are properly carried out in consideration of the number of pixels.

As described above, since the endoscope image signal processing portion 41 includes the expansion/reduction circuit 48, when cutting out an endoscope image part, the endoscope image signal processing portion 41 cuts out the endoscope image part with reference to the information of the number of pixels of the CCD 12 as well as the information of an expansion or a reduction ratio of used by the expansion/reduction circuit 48.

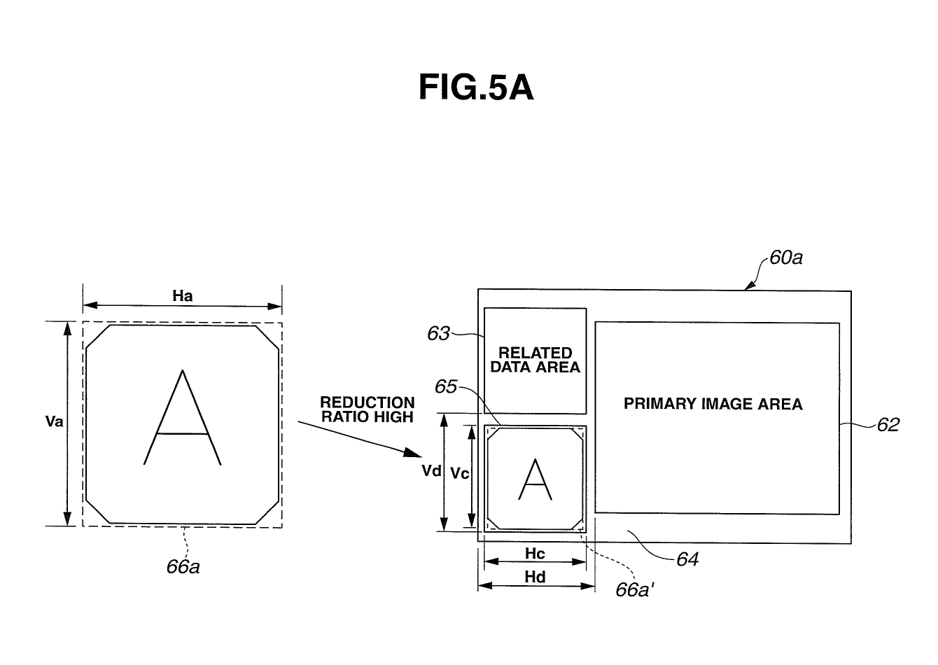

Specifically, when cutting out an endoscope image part, the endoscope image signal processing portion 41 corrects the size of an endoscope image defined by the number of pixels of the CCD 12 using an expansion or a reduction ratio from the expansion/reduction circuit 48. Then the endoscope image signal processing portion 41 cuts out the corrected size of the endoscope image part in accordance with a cutout area 66a or 66b as shown in the left side of FIG. 5A or 5B, slightly larger than the endoscope image part in a horizontal and vertical size. It should be noted that the same size of the horizontal and vertical size of an endoscope image part may be cut out.

FIGS. 5A and 5B explain how an endoscope image part (denoted by A) having a large number of pixels and an endoscope image part B having a small number of pixels are properly cut out, expanded or reduced, and held in the secondary image area 65 set in the blank area 64 as a secondary image 65a.

In the present embodiment, even if the number of pixels and a size expanded or reduced by the expansion/reduction circuit 48 of a medical image displayed as a secondary image (in a specific example, an endoscope image from the CCD 12) are different, the secondary image is enabled to be displayed in a maximum possible size within a frame indicating the horizontal and vertical sizes of the secondary image area 65.

Thus, a cutout circuit (58a) in the cutout/expansion/reduction circuit 58 cuts the endoscope image parts A and B out from image signals including an endoscope image of the secondary screen and related data as shown in the cutout areas 66a and 66b. Then, the cutout area parts including the cut-out endoscope image parts A and B are expanded or reduced with an expansion or a reduction ratio by an expansion/reduction circuit (58b) in the cutout/expansion/reduction circuit 58 to a size as close to the size of the secondary image area 65 as possible.

Specifically, since the cutout area 66a of the endoscope image part A shown in the left side of FIG. 5A is substantially larger than the secondary image area 65 in horizontal and vertical size, a high reduction rate is set (a small value of an expansion or a reduction ratio used later is set).

On the other hand, since the cutout area 66b of the endoscope image part B shown in the left side of FIG. 5B is slightly larger than the secondary image area 65 in horizontal and vertical size, a low reduction rate is set.

The cutout/expansion/reduction circuit 58 can set the cutout areas 66a and 66b so as to include the endoscope image part A or B and cut out them with reference to the information of the number of pixels of the CCD 12 acquired by the information acquiring portion 51 and the information of an expansion or a reduction ratio used by the expansion/reduction circuit 48.

For example, if it is assumed that the horizontal and the vertical sizes of the cutout area 66a are Va and Ha, and the horizontal and the vertical sizes of the secondary image area 65 are Vc and Hc, the cutout/expansion/reduction circuit 58 calculates maximum values of Ka and Kb that meet the following condition.

Va*Ka≦Vc, Ha*Kb≦Hc (1)

Further, the smaller one of the two calculated values Ka and Kb is determined as an expansion or a reduction ratio that provides horizontal and vertical sizes of the cutout area 66a including the endoscope image part A to be disposed in the secondary image area 65.

As used herein, the expansion rate means the case of expanding an image one or more times larger, and the reduction ratio means the case of reducing an image less than one time. Thus, an expansion rate may be defined as including a value equal to or smaller than one or a reduction ratio may be defined as including a value equal to or more than one, and thereby only one of the ratios may also be used.

If the cutout area expanded or reduced with the expansion rate or the reduction ratio determining the cutout area 66a is denoted by 66a′, as shown in the right side of FIG. 5A, a cutout area 66a′ including the endoscope image part A is disposed in the secondary image area 65.

As is apparent from FIG. 5A, the horizontal size of the secondary image area 65 is set at the size slightly smaller than a size Hd from the left end of the image disposition area of the image memory 60a corresponding to the display screen 61 of the monitor 6 to the left end of the primary image area 62. Similarly, the vertical size of the secondary image area 65 is set at the size slightly smaller than a size Vd from the lower end of the image disposition area of the image memory 60a to the lower end of the related data area 63.

Also, the cutout area 66b of the endoscope image part B in FIG. 5B is processed in the same manner, and as shown in the right side of FIG. 5B, a cutout area 66b′ including the endoscope image part B is disposed in the secondary image area 65.

In such a manner, the cutout/expansion/reduction circuit 58 cuts the endoscope image parts A and B as secondary images, expands or reduces the sizes of the cut-out endoscope image parts A and B and adjusts to maximum possible sizes so as to be held in the horizontal and the vertical sizes of the secondary image areas 65, and disposes the endoscope image parts A and B in the secondary image areas 65 of the image memory 60a.

The PinP composition circuit 60 reads out the image data composed of the primary image disposed in the image memory 60a, the related data of the primary image, and the secondary image as composite image data, converts the composite image data into analog composite image signals by the D/A converting circuit 35, and then outputs the signals to the monitor 6.

The monitor 6 displays a primary/secondary image as shown in the lower side of FIG. 1 if an image from the external device 2 is designated as a primary image.

In the present embodiment, a display form of a primary image made if the monitor 6 displays a primary/secondary image is designated to determine a disposition and a displayed size of the primary image to be displayed on the monitor 6 and a displayed position and a size of data relating to the primary image.

Then, the secondary image area 65 for displaying a secondary image is set in a rectangular blank area part other than the areas of the primary image in the primary screen and the related data, and the secondary image is disposed in the secondary image area 65 such that the secondary image is held in maximum possible size close to the size of the secondary image area 65.

In this case, for example, with reference to the number of pixels of the CCD 12 for an endoscope image being a secondary image if the endoscope image is expanded or reduced, with reference to information of an expansion or a reduction ratio, an endoscope image part is cut out and expanded or reduced to adjust the size to a maximum size close to that of the secondary image area 65.

In the configuration shown in FIG. 3, the positions and the sizes of the primary image in the primary screen and the related data selected by the switching circuit 52 are directly used for the display on the monitor 6.

On the other hand, as described later, as one display form of a primary image, there may be provided a function that enables changing the positions and the sizes of the primary image 62a and the related data 63a, in other words, a function that enables changing the positions and the sizes of the primary image area 62 corresponding to the display area for the primary image 62a and the related data area 63 corresponding to the display area for the related data 63a.

FIG. 6 illustrates a configuration example around a disposition setting circuit 71 that enables changing dispositions and sizes of the primary image 62a and the related data 63a by the image processing of the image signal processing portion 34.

A user provides instruction inputs, for example, through the keyboard 7 to designate information for cutting out dispositions and sizes of the primary image 62a and the related data 63a and through a disposition designating portion 7d being disposition designating means composed of the keyboard 7 to designate information of a disposition and a size of the cut-out primary image 62a and the related data. Thereby, the PinP display form setting portion 57 outputs signals corresponding to the instruction inputs to the disposition setting circuit 71 provided between the switching circuit 52 and the PinP composition circuit 60.

The disposition setting circuit 71 includes a cutout circuit 72 that receives image signals of a primary screen outputted from the switching circuit 52 as input signals and cuts out a primary image part and a related data part. Also, the disposition setting circuit 71 includes an expansion/reduction circuit 73 that expands or reduces the cut-out primary image part (and the related data part) to the designated size and an image memory 74 in which the expanded or reduced image data is disposed (stored).

The primary image part and the related data part set at the size designated by the expansion/reduction circuit 73 are each disposed (stored) in areas in the image memory 74 corresponding to the dispositions and the sizes designated through the keyboard 7. It should be noted that the related data part may not be expanded or reduced.

As in the above-described case of the cutout from an endoscope image of a secondary screen, the cutout circuit 72 cuts out each of the primary image part of the primary screen and the related data part. Then, the image data of the cutout area including the cut-out primary image part and the image data of the cutout area of the related data part are expanded or reduced to the designated size and then disposed in the image memory 74.

The image data of the cutout area including the primary image 62a disposed in the image memory 74 and the image data of the cutout area including the related data are read out at a timing synchronous with a synchronization signal from the TG 31, outputted to the PinP composition circuit 60, and stored in the image memory 60a in the PinP composition circuit 60 in the same disposition and the same size as those of the image memory 74.

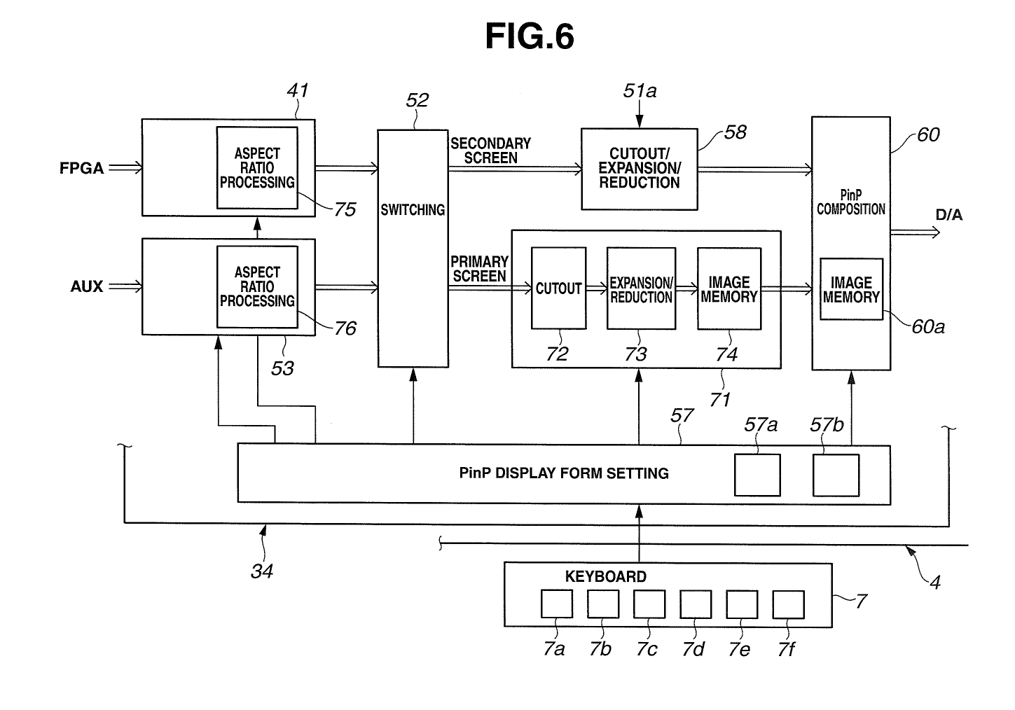

FIG. 7A illustrates a disposition example of the image memory 60a in this case (the same holds true for the image memory 74, though in FIG. 7A, cutout areas for the primary image and the related data in the image memory 74 become the primary image area and the related data area).

FIG. 7A illustrates the case where, for example, the expansion/reduction circuit 73 has an expansion rate of one. In other words, FIG. 7A corresponds to the case where only the dispositions of the primary image 62a and the related data 63a in FIG. 4 are changed without changing the sizes.

The primary image 62a in image signals of a primary screen and the related data 63a inputted from the switching circuit 52 to the disposition setting circuit 71 are in a disposed state, for example, as shown in FIG. 4.

The cutout circuit 72 cuts each of the primary image part and the related data part in accordance with the disposition information of the primary image 62a and the related data 63a.

Also, the cut-out image data in the cutout area is expanded or reduced by the expansion/reduction circuit 73 in accordance with the information of the size designated through the keyboard 7, and then disposed in the image memory 74 as the designated depositions (as in the case of the image memory 60a), for example, the dispositions of the solid lines in FIG. 7A (reference numerals 62 and 63 in FIG. 7A).

The image data of the cutout area in the primary image disposed in the image memory 74 and the image data of the cutout area in the related data are disposed in the image memory 60a of the PinP composition circuit 60. At this time, the size of each cutout area is set at the primary image area 62 including the primary image 62a and the related data area 63 including the related data 63a.

FIG. 7A shows the disposition example in which the primary image 62a and the related data 63a shown in FIG. 4 are flipped horizontally. Thus, in this case, the secondary image area 65 (in which a secondary image is disposed) will be determined as indicated by two-dot chain lines in FIG. 7A, in the horizontally-flipped position of the secondary image area 65 shown in FIG. 4.

Further, FIG. 7B illustrates an example in which the size of the primary image 62a is changed (specifically, reduced) and (the primary image area 62 of) the primary image 62a is disposed at the left side as in the case of FIG. 7A. Also, in the disposition example of FIG. 7B, the related data area 63 of the related data 63a is disposed at a right and lower side.

Also in this case, of the disposition and the size of (the primary image area 62 of) the primary image 62a and in accordance with setting of the disposition and the size of the related data area 63, the size of the secondary image area 65 in which a secondary image is disposed are determined in the blank area 64, where these areas are not disposed, as indicated by two-dot chain lines.

As an embodiment described later, image signals of an endoscope image from an endoscope apparatus being an external device 2 may be set as an external image. In such a case, the size of a primary image may be selected and set from a previously registered group of a plurality of types of sizes adopted for a displayed size of a normal endoscope image. In addition, a disposition as well as a size may also be selected and set from a registered group.

In order to simply allow such setting of a disposition and a displayed size of a primary image, the following way may be adopted.

For example, in the PinP display form setting portion 57 shown in FIG. 6, information of dispositions and displayed sizes of primary images and related data desired by users to be displayed on the monitor 6 is previously stored in a disposition information storage portion 57a as disposition/displayed size information.

Also, in order that a user can select disposition/displayed size information, for example, the keyboard 7 has a function of a disposition/displayed size selecting portion 7e being disposition/displayed size selecting means for selecting a disposition/displayed size corresponding to a desired disposition and displayed size.

It should be noted that in the present embodiment, the keyboard 7 has functions of a variety of instructions and setting, but in addition to the keyboard 7, a mouse and a pointing device may also be used.

Such a configuration enables a user to simply designate a disposition and a displayed size of a primary image and display the primary image in a designated desired disposition and displayed size.

Selection information of a disposition/displayed size from the keyboard 7 is sent from the PinP display form setting portion 57 to the information acquiring portion 51. Then, based on the selection information of the disposition/displayed size of a primary image and related data, the secondary image area 65 in which a secondary image is disposed is determined as described above, and the secondary image is disposed in the secondary image area 65.

Also, there may be a function of displaying, for example, a menu screen on the monitor 6 to set an aspect ratio of a composite image to be displayed on the monitor 6. For example, FIG. 6 shows an example in which processing circuits for setting an aspect ratio of a composite image are provided (the circuits may also be applied to the configuration shown in FIG. 3).

In this case, for example, the keyboard 7 has a function of an aspect ratio setting portion 7f being aspect ratio setting means through which a user provides an instruction to set aspect ratios of both a primary image and a secondary image in a composite image. In response to the instruction provided through the keyboard 7 to set aspect ratios, the PinP display form setting portion 57 sends setting signals for setting the designated aspect ratios to, for example, aspect ratio processing circuits 75 and 76 provided in the endoscope image signal processing portion 41 and the external image signal processing portion 53, respectively.

The aspect ratio processing circuits 75 and 76 perform image processing that sets an endoscope image and an external image to designated aspect ratios. Then, the image processing subsequent to the switching circuit 52 for generating a composite image in PinP is performed on the endoscope image and external image with the aspect generated ratios similarly to the foregoing embodiment.

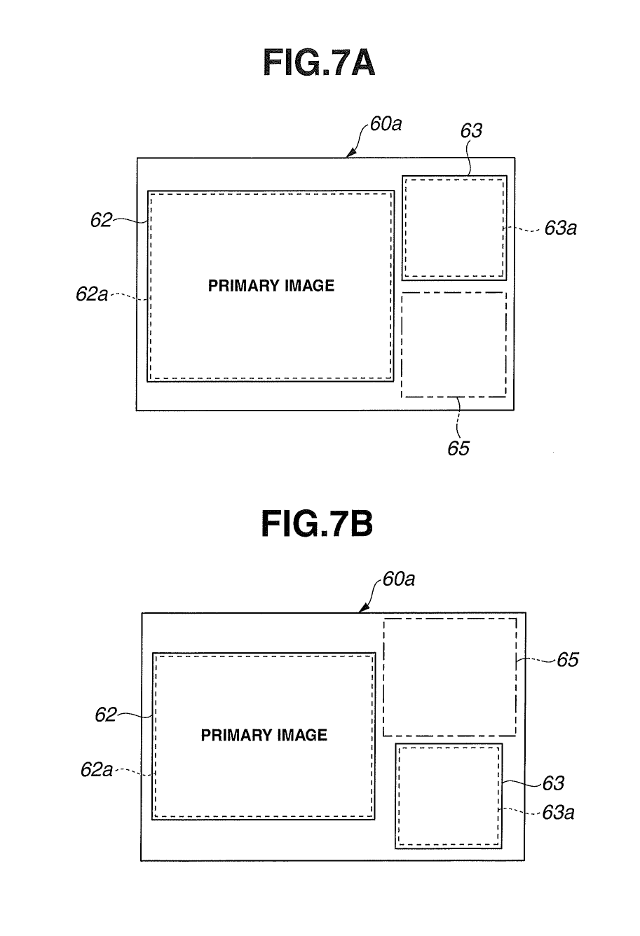

FIG. 8 illustrates a display example of a composite image generated in this manner, on the monitor 6. FIG. 8 illustrates an example corresponding to the case of the instruction to set an aspect ratio of, for example, 16:9. Also in this case, the primary image 62a and the secondary image 65a each set at 16:9 are set to be displayed without overlapping each other and the secondary image 65a is set to be displayed in a secondary image area in the maximum possible size in a horizontal direction.

In the case of the specific example in FIG. 8, due to the condition of the designated aspect ratio, the condition of expression (1) will be substantially determined by the expansion or the reduction ratio Kb of one of the sides.

In the display example shown in FIG. 8, the secondary image 65a is an endoscope image associated with a surgical endoscope as described below.

In the case of the image processing in a surgical endoscope, an image picked up by a CCD incorporated in the surgical endoscope is displayed as an endoscope image without being masked.

On the other hand, in the case of the image processing in a medical endoscope such as the endoscope 3 described above, the endoscope image signal processing portion 41 of the processor 4 masks the four corners of an image picked up by the CCD 12, and the monitor 6 displays the masked endoscope image.

Thus, in the foregoing embodiment, a cutout area or a condition of the cutout area may be further changed in accordance with a type of endoscope. In this case, the CCD sensing circuit 36 shown in FIG. 2 includes an endoscope type sensing function of sensing information of the number of pixels of the CCD 12 as well as sensing a type of endoscope, and outputs the sensed information to the information acquiring portion 51 shown in FIG. 3. The information acquiring portion 51 acquires information of the number of pixels of the CCD 12 as well as information of a type of the endoscope 3.

Examples of information of a type of the endoscope 3 include information whether the endoscope 3 is a medical endoscope or a surgical endoscope.

As described above, the information acquiring portion 51 has determined a cutout area for an endoscope image to be displayed as a secondary image based on information of a CCD type or the like, but in the present modified example, a cutout area is determined to be changed further in accordance with information of an endoscope type, that is, in accordance with the case of a medical endoscope or the case of a surgical endoscope.

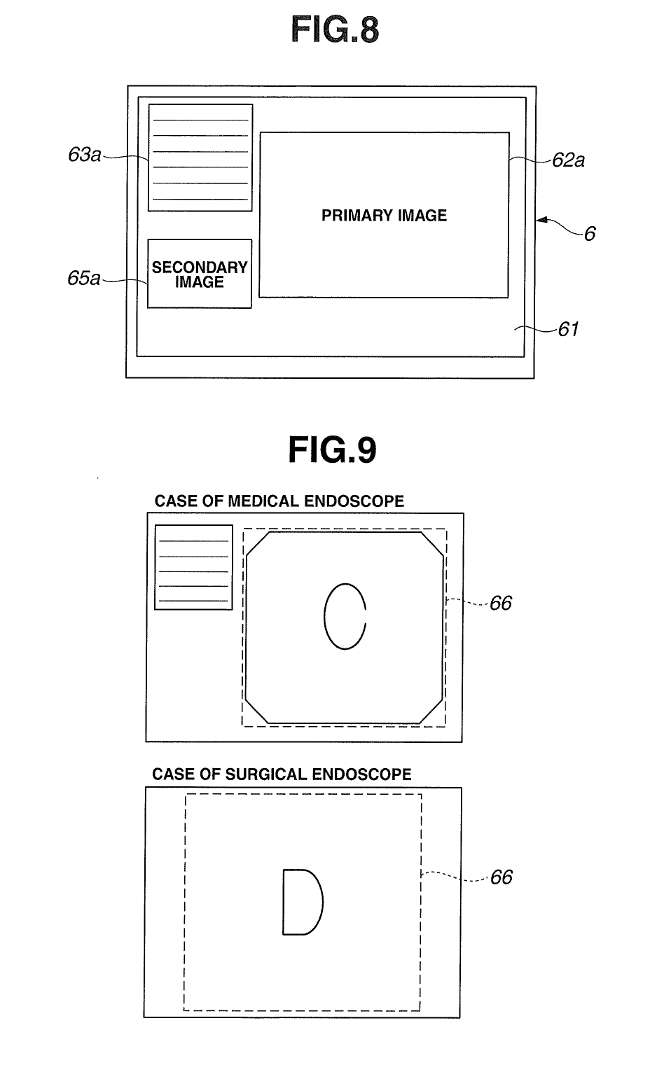

Then, a cutout circuit (hereinafter 58a) in the cutout/expansion/reduction circuit 58 cuts an endoscope image as shown in FIG. 9.

The upper side of FIG. 9 shows a cutout area 66 with dotted lines in the case of a medical endoscope if an endoscope image part indicated with solid lines is cut out from image signals of a secondary screen outputted from the switching circuit 52, and the lower side shows a cutout area 66 in the case of a surgical endoscope.

In the case of a medical endoscope, a horizontal and vertical cutout area 66 is set with a masking frame of an octangular endoscope image C held therein, and an endoscope image part is cut out in the cutout area 66. Also, an upper left part adjacent to the octangular endoscope image part is related data relating to the endoscope image.

On the other hand, in the case of a surgical endoscope, an image picked up by a CCD is directly processed and displayed as a rectangular endoscope image D without being masked. Then, a cutout area 66 of a horizontal and vertical size including a center area of the rectangular endoscope image D is set.

For example, information of a plurality of cutout areas of different horizontal and vertical sizes is registered in the PinP display form setting portion 57 in advance for a user to allow for selecting one cutout area from the information of the cutout areas through, for example, the keyboard 7, and thereby the user can cut out a desired cutout area 66.

To this end, for example, the PinP display form setting portion 57 shown in FIG. 6 may include a cutout area information storage portion 57b composed of a non-volatile memory or the like in which cutout area information is stored. Also, the cutout area information storage portion 57b may also be provided outside the PinP display form setting portion 57, but within the processor 4. Then, the keyboard 7 forms means for designating a cutout area.

It should be noted that in the above description, the aspect ratio processing circuits 75 and 76 have been provided in the external image signal processing portion 53, but the above-described cutout circuit 72 for cutting out a primary image may also be used for aspect ratio processing.

It should be noted that in the above description, instructions are provided to designate an image from the external device 2 as a primary image and designate an image from the endoscope 3 as a secondary image, but if image signals from the external device 2 and image signals from the endoscope 3 are reversed, substantially the same effects can be given.

For example, if a display form in which an image from the endoscope 3 is a primary image is designated, the primary image 62a shown in FIG. 4 is an endoscope image and the related data 63a is (an image of) data relating to the endoscope image.

Such dispositions are determined by an instruction provided through the keyboard 7 and an expansion or a reduction ratio used by the expansion/reduction circuit 48, and the information acquiring portion 51 acquires such disposition information. Also, the secondary image area 65 for an external image part from the external device 2 is determined in the blank area 64, other than the areas where these images are disposed (i.e., having no displayed image). The information acquiring portion 51 also acquires the information of the secondary image area 65.

Then, an external image part is cut out from image signals from the external device 2 to be held within the size of the secondary image area 65 by the cutout/expansion/reduction circuit 58, and expanded or reduced. The description corresponds to FIGS. 5A and 5B if an endoscope image is replaced by an external image.

Thus, according to the present embodiment, in the case where one of a plurality of images are preferentially displayed in a display form, without the images overlapping each other, the subordinately disposed images can be generated in the maximum possible size.

In this case, even if the sizes of secondary images being the subordinately disposed images are changed by the number of pixels of the image pickup device, or expanding or reducing means, without the images overlapping each other, the subordinate images can be generated in the maximum possible size.

Also, according to the present embodiment, in the case of s primary/secondary image, dispositions and displayed sizes of the primary/secondary image can be changed. Thus, an operator can smoothly carry out endoscopy and the like by setting a desired disposition state and displayed size to display a primary/secondary image on the monitor 6.

Also, in the case of displaying a primary/secondary image, if an operator designates a disposition of a primary image, a disposition and a displayed size of a secondary image are automatically and properly set in a blank area, so that a convenient system can be embodied. Also, in the case of designating an aspect ratio to display a primary/secondary image, without the primary and the secondary images overlapping each other, the secondary image can be displayed in the maximum possible size.

It should be noted that as indicated by the dotted lines in FIG. 2, for example, a non-volatile rewritable memory (e.g., a flash memory) 32c connected to the CPU 32b may be provided, and the memory 32c may include a composite image set information storage portion 32d in which a user name (or user identification information) used if composite image is displayed using the image composition system 1 and set information (information of dispositions of a primary image, a secondary image and the like, sizes of the dispositions, aspect ratios and the like) of the composite image to be displayed on the monitor 6 are stored in association with each other.

Then, when the user uses the image composition system 1 next time, the CPU 32b may read out the set information of the composite image from the corresponding composite image set information storage portion 32d based on the user name or the like and display the set information on the monitor 6 to ask the user whether to generate a composite image with the set information displayed on the monitor 6. If the user generates the composite image with the same set information, simple answers such as OK, YES or the like will suffice.

Such a configuration enables a user to, if the user sets composite image generation with the user's desired set information, simply generate a composite image with the same set information at the next use, and thus user operability can be substantially improved.

In addition to the set information for individual users, a function of allowing general users to simply generate composite images by inputting selection instructions may be added.

A plurality of different representative set information items with different setting conditions needed to generate composite images are stored in the set information storage portion 32d of the memory 32c. When a user uses the image composition system 1, the CPU 32b controls to display a plurality of the representative set information items on the monitor 6. The user can select desired one from the representative set information items to simply generate a composite image. Also in this case, advantageously, the user can simply generate a desired composite image by inputting selection instructions.

### Second Embodiment

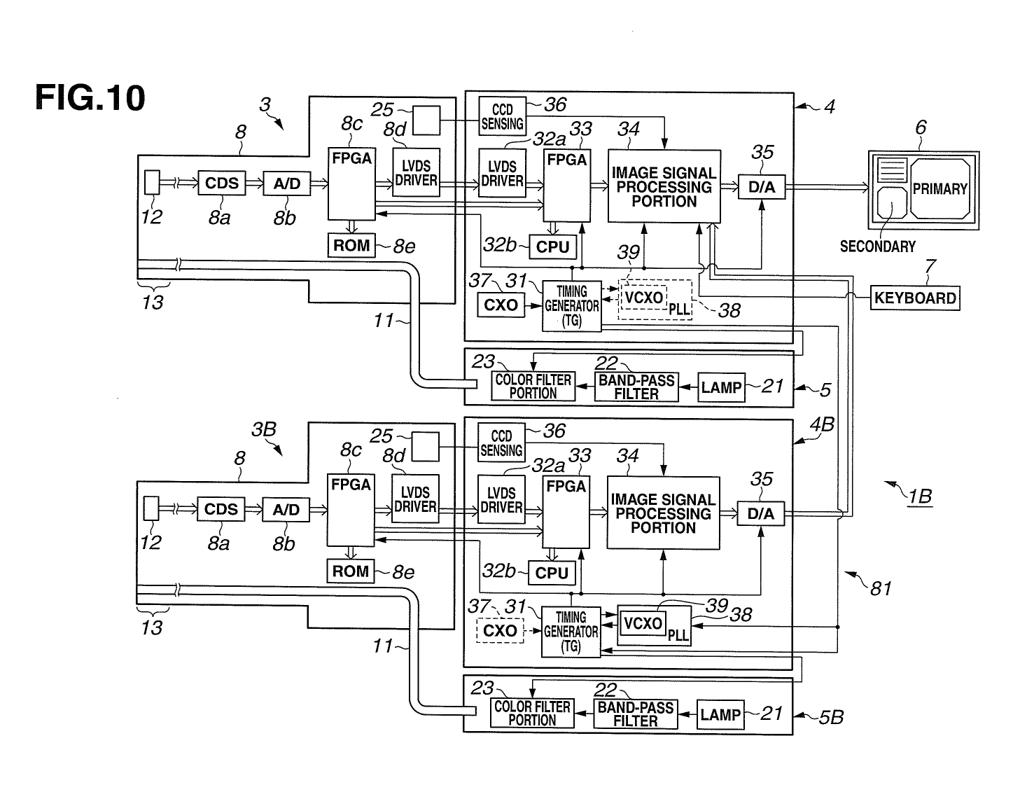

Next, a second embodiment of the present invention will be described with reference to FIG. 10. The image composition system 1B of the present embodiment has a configuration in which the external device 2 in the first embodiment described above is replaced by an endoscope apparatus 81.

The image composition system 1B of the present embodiment includes a main side endoscope apparatus including the endoscope 3, the processor 4, the light source apparatus 5, the monitor 6 and the keyboard 7 as described in the first embodiment, and the slave side endoscope apparatus 81 configuring an external device.

The endoscope apparatus 81 includes a slave side endoscope (also simply referred to as endoscope) 3B, a slave side processor (also simply referred to as processor) 4B that performs image processing on the endoscope 3B, and a slave side light source apparatus (also simply referred to as light source apparatus) 5B that supplies illuminating light to the light guide 11 of the endoscope 3B.

Since the endoscope 3B includes the same components (constituent members) as those of the endoscope 3, the same reference numerals are assigned to the components of the endoscope 3 used and descriptions thereof will be omitted. Also, the processor 4B has substantially the same configuration as that of the processor 4, and the same reference numerals are assigned to the same components as those of the processor 4 and descriptions thereof will be omitted. Further, the light source apparatus 5B has the same configuration as that of the light source apparatus 5, and the same reference numerals are assigned to the same components as those of the light source apparatus 5 and descriptions thereof will be omitted.

The image signal processing portion 34 provided in the processor 4B has an external input terminal to which an image signal is inputted from the outside, but the external input terminal is not connected with an external device. On the other hand, an external input terminal of the processor 4 is connected with an output terminal of the processor 4B, and analog image signals including an endoscope image outputted from the processor 4B are inputted to the external input terminal.

Then, if an instruction is provided through the keyboard 7 to designate a display form in which, for example, an image from the processor 4B, that is, an endoscope image picked up by the endoscope 3B is a primary image, a composite image in PinP in which the endoscope image is the primary image and an endoscope image picked up by the endoscope 3 is a secondary image is displayed on the monitor 6.

Also, the processor 4 outputs RGB index signals generated by the TG 31 to the color filter portion 23 of the light source apparatus 5, and similarly the processor 4B also outputs RGB index signals generated by the TG 31 to the color filter portion 23 of the light source apparatus 5B.

Also, in the image composition system 1B of the present embodiment, both the light source apparatuses 5 and 5B are light source apparatuses with the frame-sequential scheme. The light source apparatuses 5 and 5B and the processors 4 and 4B perform illuminating and image processing in synchronization with each other.

Thus, the TG 31 in the processor 4 outputs synchronization signals of horizontal synchronization signals and vertical synchronization signals that are timing signals, and RGB index signals to the TG 31 and the PLL circuit 38 in the processor 4B. Also, the TG 31 in the processor 4 uses a reference clock of the CXO circuit 37 to generate a timing signal in the same manner as the first embodiment.

On the other hand, the TG 31 of the processor 4B uses the PLL circuit 38 instead of a reference clock of the CXO circuit 37. Then, the PLL circuit 38 uses a synchronization signal inputted from the processor 4 as a reference signal to generate a reference clock phase-locked with a reference clock of the CXO circuit 37 of the processor 4 by a VCXO circuit 39, and further generate an RGB index signal and a synchronization signal phase-locked with the reference clock.

Thus, both the light source apparatuses 5 and 5B and the processors 4 and 4B perform frame-sequential illuminating and image processing in synchronization with each other.

Such synchronous illuminating and image processing enables an operator to smoothly observe, diagnose, and treat an affected area in a body under endoscopic observation by using both the endoscopes 3 and 3B simultaneously. That is, if such synchronous illuminating and image processing are not performed, the frame-sequential illumination timing of both the light source apparatuses 5 and 5B is off, and accordingly a color reproducing function deteriorates.

According to the present embodiment, such function deterioration can be prevented and the same color reproducing function as that obtained if each of the endoscopes 3 and 3B is independently used can be ensured. Then, by using the two endoscopes 3 and 3B, an operator can carry out diagnosis more smoothly. In addition, the same effects as those in the first embodiment are given.

### Third Embodiment

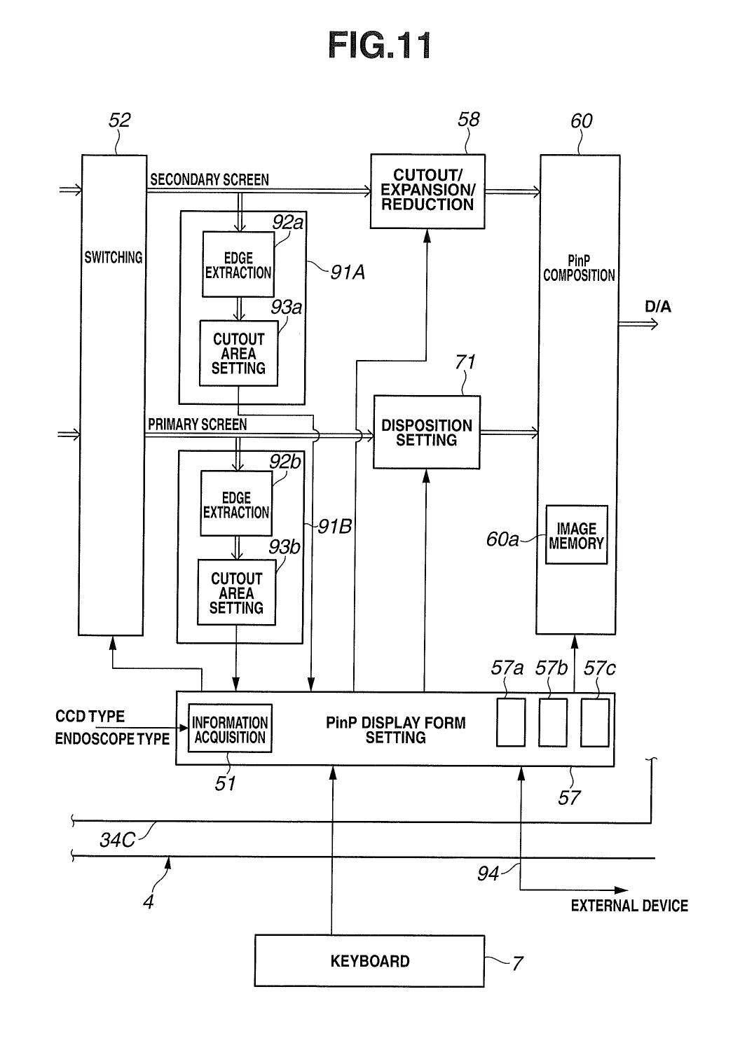

FIG. 11 illustrates a partial configuration of the image signal processing portion 34C in the processor 4 according to a third embodiment of the present invention. In the foregoing embodiments, a secondary image part has been cut out from image signals of a secondary screen or a primary image part has been cut out from a primary screen with reference to information from the keyboard 7 or the like.

In the present embodiment, on the other hand, for example, each of a cutout area cut out by the cutout/expansion/reduction circuit 58 shown in FIG. 6 and a cutout area cut out by the cutout circuit 72 of the disposition setting circuit 71 are automatically determined using edge extraction from inputted image signals and then cut out.

Thus, for example, in the configuration in FIG. 6, cutout area detecting circuits 91A and 91B are further provided for receiving image signals of a primary screen and image signals of a secondary screen outputted from the switching circuit 52 as input signals to detect cutout areas of a primary image part and a related data part, and a cutout area of a secondary image.

It should be noted that the cutout area detecting circuits 91A and 91B may be provided at an inputting side of the switching circuit 52. Also, in the present embodiment, the PinP display form setting portion 57 is adopted which has a slightly modified configuration as compared with the configuration shown in FIG. 6.

The cutout area detecting circuits 91A and 91B include edge extracting circuits 92a and 92b that extract edge parts from inputted image signals and cutout area setting circuits 93a and 93b that set cutout areas from the edge information extracted from the edge extracting circuits 92a and 92b.

The edge extracting circuits 92a and 92b extracts edge parts from image signals by, for example, a comparing circuit comparing edge enhancement signals obtained by an edge enhancing circuit enhancing image signals with a threshold level to extract signals exceeding the threshold level.

The cutout area setting circuits 93a and 93b identify a frame part of a tetragonal or an octangular image from the extracted edge part. In this case, an identification function may be improved with other processing such as selecting a frame part that meets a pre-registered condition of a cutout area (e.g., a size condition of a cutout area) by pattern matching between an extracted edge part and a pre-registered frame shape, for example. Then, if the identified frame shape is tetragonal, the frame is set at a cutout area, and if octangular, a tetragonal frame part extrapolated so as to include the octagon is set at a cutout area of an image part. It should be noted that the octagon may also be directly set at a cutout area.

Also, the cutout area setting circuits 93a and 93b performs pattern matching or the like between information of an extracted edge part and registration information previously obtained by edge extraction of character information to determine an area having a related data part based on whether the related data part is composed of character information, and sets a tetragon including the area to a cutout area of the related data.

Depending on an external device, image signals may not include related data, so that a cutout area of related data may not be detected or a cutout area may be zero. In this manner, the cutout area setting circuits 93a and 93b use information of a cutout area of an image part and a cutout area of related data for setting a cutout area cut out by the cutout circuit 72 in the disposition setting circuit 71 and a cutout area cut out by the cutout/expansion/reduction circuit 58, for example, through the PinP display form setting portion 57.

Also, in the present embodiment, CCD type information sensed by the CCD sensing circuit 36 and endoscope type information are inputted, for example, into the information acquiring portion 51 in the PinP display form setting portion 57.

The information acquiring portion 51 shown in FIG. 3 has set a cutout area in accordance with a type of the CCD 12, but in the configuration according to the present embodiment illustrated in FIG. 11, information such as a type of the CCD 12 may not be necessary. Of course, such information may be combined or a cutout area may be determined using one of the two items of information preferentially.

The PinP display form setting portion 57 generates a composite image as a primary/secondary image in a display form designated by a user using a variety of instruction inputs provided through the keyboard 7 and information from the cutout area setting circuits 93a and 93b.

Also, in the present embodiment, there may be a control function under which the presence/absence of an image signal is monitored (determined) as described later, and if it is determined that an image signal is not inputted, in a composite image such as a primary/secondary image, the display of one of the primary and secondary images is automatically changed to a predetermined size such as a normal image size. First, the case in which the external device 2 is disconnected from the processor 4 will be described.

Also, the cutout area detecting circuits 91A and 91B in the present embodiment form monitoring means for monitoring the presence/absence of an image signal. For example, if the edge extracting circuits 92a and 92b determine that an edge part cannot be extracted because a level of an input signal is equal to or less than a threshold, close to 0, and does not have a predetermined signal level, the cutout area detecting circuits 91A and 91B determine whether or not an image signal includes a synchronization signal composed of a horizontal and a vertical synchronization signals.

Then, if the cutout area detecting circuits 91A and 91B determine that an image signal does not include a synchronization signal, the cutout area detecting circuits 91A and 91B determine that an image signal from the external device 2 is not inputted, and outputs, to the PinP display form setting portion 57, a determination signal that an image signal from the external device 2 is not inputted. It may be determined that an image signal is not inputted without determining the presence/absence of a synchronization signal.

If the determination signal is inputted, the PinP display form setting portion 57 controls the switching circuit 52, the cutout/expansion/reduction circuit 58, and the disposition setting circuit 71 so as to output the inputted image signal directly to the PinP composition circuit 60 as a primary image, for example.

As a specific example, while the endoscope 3 and the external device 2 are connected to the processor 4, and image signals of an endoscope image from the endoscope 3 and image signals from the external device are inputted to the switching circuit 52, if the external device 2 is disconnected from the processor 4, a set display state is changed from the display in which both the images are displayed as a composite image being a primary/secondary image to the display in which only the endoscope image is displayed.

Even if an external image from the external device 2 is set to a primary image and an endoscope image is set to a secondary image, once the external device 2 is disconnected from the processor 4, the endoscope image is enabled to be automatically displayed as not a secondary image but a normal sized endoscope image. Thus, if a user disconnects the external device 2 from the processor 4, an operation to change the setting of a primary/secondary image becomes unnecessary, so that user operability can be improved.

The foregoing example has described the case in which the external device 2 is disconnected, but the example may be applied to the case in which the endoscope 3 is disconnected from the processor 4 for the purpose of replacement or the like. If the endoscope 3 is disconnected, since the image signal input stops, one of the cutout area detecting circuits 91A and 91B detects the fact and changes a display form from a primary/secondary image to an image to which image signals are inputted in a normal size. Also in this case, user operability can be improved.

Also, in the present embodiment, if an instruction is provided through the keyboard 7 to designate dispositions and displayed sizes of a primary image and related data, the PinP display form setting portion 57 controls the disposition setting circuit 71 to dispose the primary image and the related data in accordance with the instruction.

Also, based on the dispositions, the PinP display form setting portion 57 sets a secondary image area in the blank area. Then, the disposition setting circuit 71 further controls an operation performed by the cutout/expansion/reduction circuit 58, such as cutting a secondary image part out from image signals of a secondary screen.

In this case, the PinP display form setting portion 57 grasps a disposition state of a composition primary/secondary image. Then, for example, if an aspect ratio designated by a user or a present aspect ratio is changed, for example, if a larger displayed size of a secondary image can be more properly generated and displayed as a composite image, the fact may be displayed for the user.

Thus, for example, if an aspect ratio of a primary image in a presently set disposition state of a composite image in PinP can be changed, the display form setting portion 57 may determine whether or not the size of a secondary image area can be increased by changing the disposition state of the primary image within a changeable range of the aspect ratio.

Also, as described above, as an external device, an ultrasound apparatus may be connected which includes, for example, acoustic image pickup means and outputs image signals of an ultrasound image. When such a particular external device is connected with the processor 4, if the PinP display form setting portion 57 identifies the external device as an ultrasound apparatus being a particular external device, the PinP display form setting portion 57 may set an ultrasound image to a primary image and an endoscope image to a secondary image preferentially to an instruction to set a display form.

Thus, the PinP display form setting portion 57 communicates with an external device, for example, via a communication line 94 and includes an identifying portion 57c that acquires an identification code or the like of the external device to identify a type of the external device based on the identification code or the like. Then, if the identifying portion 57c identifies the external device as a particular external device, an image may be set to a particular PinP display form in accordance with the identification result.

Also, in this case, if the image is displayed in PinP, dispositions of a primary and a secondary image may be a particular disposition state, for example, a disposition state in which an ultrasound image is displayed as a primary image, and an endoscope image is displayed as a secondary image in an upper right side from the primary image, like the disposition shown in FIG. 7B.

The other components are the same as those in the first embodiment described above.

According to the present embodiment, as compared with the first embodiment, without setting cutout areas of a primary image part and a related data part from image signals of a primary screen and without setting a cutout area of a secondary image part from image signals of a secondary screen, both the cutout areas can be automatically set based on both the image signals. As such, since users do not have to identify cutout areas and sizes of image parts in both the images signals, convenience of the users is improved.

Also, for example, even if the size of an image part in image signals from an external device is changed, in the present embodiment, the image part can be swiftly cut out in the changed cutout area, so that convenience of the users is improved.

In addition, the same effects as those of the first embodiment are given.

In the embodiments hereinbefore described, it has been assumed that, in most case, image signals of a primary screen include a primary image as well as related data relating to the primary image, but it is apparent that the embodiments may be applied to the case where related data is not included.

For example, a description will be made with reference to FIG. 4, in the image disposition area of the image memory 60a, if image signals of a primary screen include only the primary image 62a and do not include related data, the tetragonal secondary image area 65 is set in the blank area 64 other than the primary image area 62, in which the primary image 62a is disposed, and a secondary image is disposed in the secondary image area 65.

In the case of FIG. 4, the secondary image area 65 is not limited to a disposition indicated by two-dot chain lines and may be disposed above the two-dot chain lines (a side of the related data area 63). If related data is not considered in this case, a user can more freely select a position at which a secondary image is disposed. If a position at which a secondary image is disposed has a degree of freedom in this way, the position may be determined in accordance with a preset condition (e.g., a condition in which if a blank area has a plurality of positions in the vertical direction where a secondary image is to be disposed, for example, the bottom position has priority).

Also, depending on a disposition or a size of a primary image, a size of a secondary image area in which a secondary image is disposed can be increased. Also, if a secondary screen includes a secondary image as well as related data relating to the secondary image, the related data of the secondary image may be disposed in the related data area 63 described above.

It should be noted that a different embodiment may be configured by partly combining some of the above-described embodiments, and such an embodiment belongs to the present invention.

What is claimed is:

1. An image composition system for receiving a first image and a second image and outputting a composite image, the system comprising:
an image related information acquiring portion that acquires image related information between the first image and the second image;
an image display form designating portion that designates a display form of the first image preferentially to the second image;
a second image display form determining portion that determines a display form of the second image so as to display the second image in a predetermined area of the first image based on the image related information of the second image, the information being acquired by the image related information acquiring portion, and the designation of the image display form designating portion;
a second image processing portion that processes the second image based on the determination by the second image display form determining portion; and
an image compositing portion that outputs a composite image obtained by compositing the second image processed by the second image processing portion on the predetermined area of the first image.

2. The image composition system according to claim 1, wherein the system includes the first image and two medical images being the second image, or the two medical images and an image of data relating to the medical images;
the image related information acquiring portion acquires the image related information including display form information of areas of the medical images relating to the first image and the second image, an area of the image of the data relating to the medical image, and an area with no display;
the second image display form determining portion determines a medical image part of the second image to be held in an area with no medical image of the first image;
the second image processing portion extracts only the medical image part of the second image and expands or reduces the extracted medical image part to be held in the display form determined by the second image display form determining portion; and
the image compositing portion composites the image processed by the second image processing portion on the area with no display of the medical image of the first image.

3. The image composition system according to claim 2, further comprising:
an aspect ratio setting portion that sets an aspect ratio of the composite image; and a first image processing portion that processes the first image based on the aspect ratio set by the aspect ratio setting portion,
wherein the second image display form determining portion determines a display form of the second image to be held in the area with no display of the first image having the aspect ratio set by the aspect ratio setting portion and processed by the first image processing portion.

4. The image composition system according to claim 2, wherein
the image display form designating portion includes a disposition setting portion that enables changing dispositions of the medical image of the first image and the data relating to the medical image.

5. The image composition system according to claim 4, wherein
the disposition setting portion enables changing a size of the medical image being the first image in accordance with the designation by the image display form designating portion.

6. The image composition system according to claim 5, wherein
the second image processing portion includes an image processing portion that performs image processing with changing parameters for determining image processing characteristics in accordance with whether the second image is a colored image or a monochrome image.

7. The image composition system according to claim 5, wherein
the medical image being the second image is an endoscope image picked up by an endoscope including an image pickup device, and the second image processing portion changes, in accordance with a type of the endoscope, a condition of a cutout area for cutting out an endoscope image part of the second image.

8. The image composition system according to claim 5, further comprising:
a first cutout circuit that performs image processing for cutting only the medical image part out from first image signals including the medical image being the first image by edge extraction from the first image signals; and a second cutout circuit that cuts only the medical image part out from second image signals including the medical image being the second image by edge extraction from the second image signals.

9. The image composition system according to claim 1, wherein
the image composition system monitors presence/absence of an image signal of the first image and an image signal of the second image inputted to the image composition system, and if a determination result indicates that one of the image signals is not inputted, the image composition system switches from the composite image composited by the image compositing portion using the first image and the second image, to display only the other image in a predetermined size.

10. The image composition system according to claim 1, further comprising
a set information storage portion in which information of a user who uses the image composition system and set information used when the composite image is generated in association with the information of the user are stored with the user information and set information linked with each other.

11. The image composition system according to claim 1, further comprising
a set information storage portion in which a plurality of set information items used when the composite images are generated with different set conditions are stored, thereby allowing a user who uses the image composition system to select one of the plurality of set information items that is to be actually used.
